(19) United States
(12) Patent Application Publication
(10) Pub. No.: US 2026/0149213 A1
(43) Pub. Date: May 28, 2026

(54) CHARGING DOCK HOUSING ASSEMBLY, CHARGING DOCK MODULE AND CHARGING DOCK

(71) Applicants: Tyco Electronics (Shanghai) Co., Ltd., Shanghai (CN); Tyco Electronics Technology (SIP) Co., Ltd., Suzhou (CN)

(72) Inventors: Fangyue (Jason) Zhu, Shanghai (CN); Renyi (Ronny) Dou, Suzhou (CN); Tiancheng Cao, Suzhou (CN); Hong (Vicky) Liu, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/401,758

(22) Filed: Nov. 26, 2025

(30) Foreign Application Priority Data
Nov. 26, 2024 (CN) 202411709058.3

(51) Int. Cl. H01R 13/424; H01R 13/52; H01R 13/66

(52) U.S. Cl. CPC H01R 13/424; H01R 13/5205; H01R 13/521; H01R 13/6683

(57) ABSTRACT

A charging dock housing assembly includes a housing which is formed with a terminal insertion hole and an installation slot. The charging dock housing assembly further includes a locking component which is installed into the installation slot of the housing. The locking component of the charging dock housing assembly includes a protruding tongue extending into the terminal insertion hole, the protruding tongue rests against a terminal inserted into the terminal insertion hole to lock the terminal in the terminal insertion hole.

### CROSS-REFERENCE TO RELATED APPLICATION

This application claims the benefit of the filing date under 35 U.S.C. § 119(a)-(d) of Chinese Patent Application No. 202411709058.3, filed on Nov. 26, 2024.

### FIELD OF THE INVENTION

The present invention relates to a charging dock housing assembly, a charging dock module comprising the charging dock housing assembly, and a charging dock comprising the charging dock module.

### BACKGROUND OF THE INVENTION

A charging dock commonly includes a housing and charging terminals inserted into the housing. In order to reliably lock the charging terminal in the housing, a locking component needs to be installed on the lead frame inside the charging dock, which can move between a locking position engaged with the charging terminal and an unlocking position separated from the charging terminal.

There is a hole formed in the rear end cover of the housing that allows the insertion of an operating tool. After the charging terminal is inserted into the housing, the operating tool is inserted into the housing and used to move the locking component to the locking position. When it is necessary to remove the charging terminal from the housing, the operating tool is inserted into the housing and used to move the locking component to the unlocking position. The operation and use of the locking component of the existing charging dock is very inconvenient.

### SUMMARY OF THE INVENTION

A charging dock housing assembly includes a housing which is formed with a terminal insertion hole and an installation slot. The charging dock housing assembly further includes a locking component which is installed into the installation slot of the housing. The locking component of the charging dock housing assembly includes a protruding tongue extending into the terminal insertion hole, the protruding tongue rests against a terminal inserted into the terminal insertion hole to lock the terminal in the terminal insertion hole.

### BRIEF DESCRIPTION OF DRAWINGS

In the following, the present invention is described in more detail with references to the drawings in which:

FIG. 1 shows an illustrative perspective view of a charging dock according to an exemplary embodiment of the present invention;

FIG. 2 shows an illustrative exploded view of a charging dock according to an exemplary embodiment of the present invention;

FIG. 3 shows an axial sectional view of a charging dock according to an exemplary embodiment of the present invention;

FIG. 4 shows an illustrative perspective view of a charging dock module according to an exemplary embodiment of the present invention;

FIG. 5 shows an axial sectional view of a charging dock module according to an exemplary embodiment of the present invention;

FIG. 6 shows an illustrative exploded view of a charging dock module according to an exemplary embodiment of the present invention;

FIG. 7 shows an exploded sectional view of a charging dock module according to an exemplary embodiment of the present invention;

FIG. 8 shows an illustrative perspective view of three terminals and locking components of a charging dock module according to an exemplary embodiment of the present invention;

FIG. 9 shows a plan sectional view of a charging dock module according to an exemplary embodiment of the present invention;

FIG. 10 shows an illustrative perspective view of the locking component of the charging dock module according to an exemplary embodiment of the present invention when viewed from the top;

FIG. 11 shows an illustrative perspective view of the locking component of the charging dock module according to an exemplary embodiment of the present invention when viewed from the bottom; and

FIG. 12 shows an illustrative perspective view of the housing of a charging dock module according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

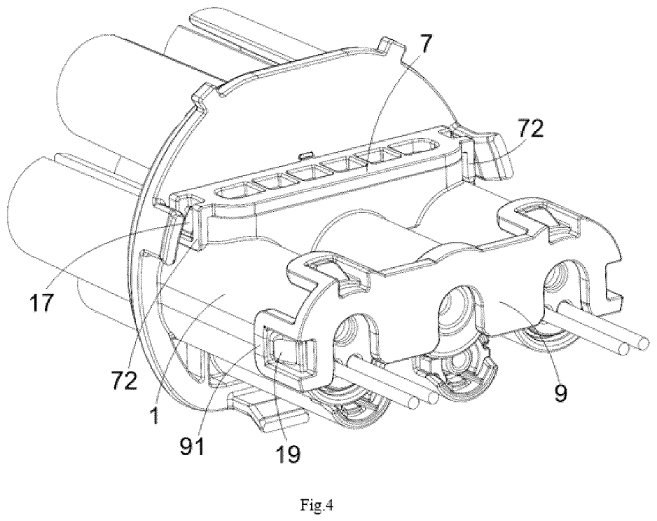

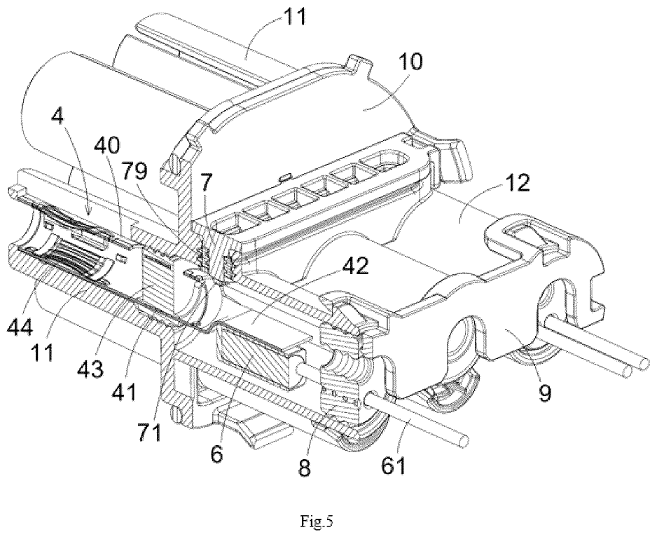

In an exemplary embodiment of the present invention, a charging dock housing assembly is disclosed. The charging dock housing assembly includes, as shown in FIG. 4, a housing 1 and a locking component 7. The housing 1 is formed with a terminal insertion hole 101 and an installation slot 102. The locking component 7 is installed into the installation slot 102 of the housing 1. The locking component 7 includes a protruding tongue 71, shown in FIG. 5, that extends into the terminal insertion hole 101, which is used to rest against a terminal 4 inserted into the terminal insertion hole 101 to lock the terminal 4 in the terminal insertion hole 101.

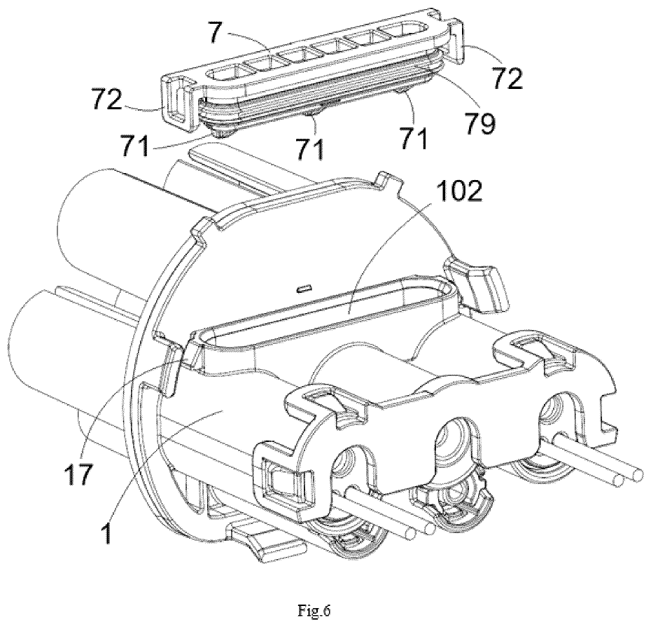

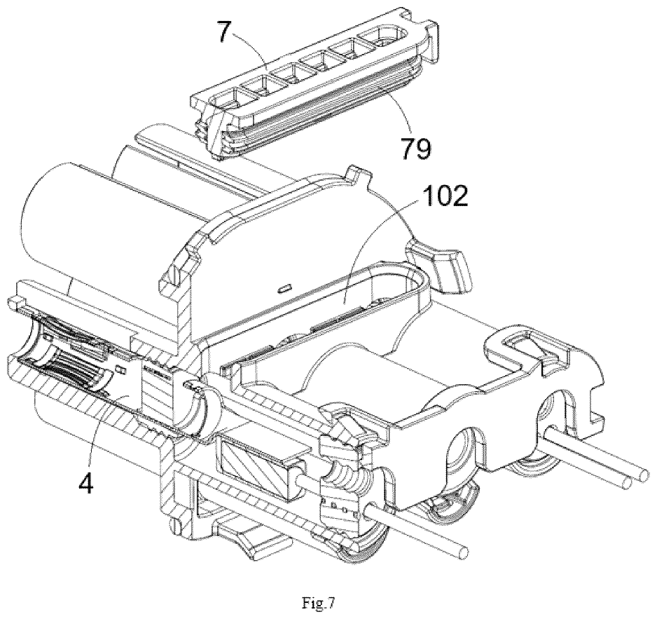

As shown in FIGS. 5 to 7 and 9, in the illustrated embodiment, the charging dock housing assembly further includes a sealing ring 79, which is fitted on the locking component 7 and radially compressed between the inner wall surface of the installation slot 102 and the locking component 7 to achieve sealing between the two.

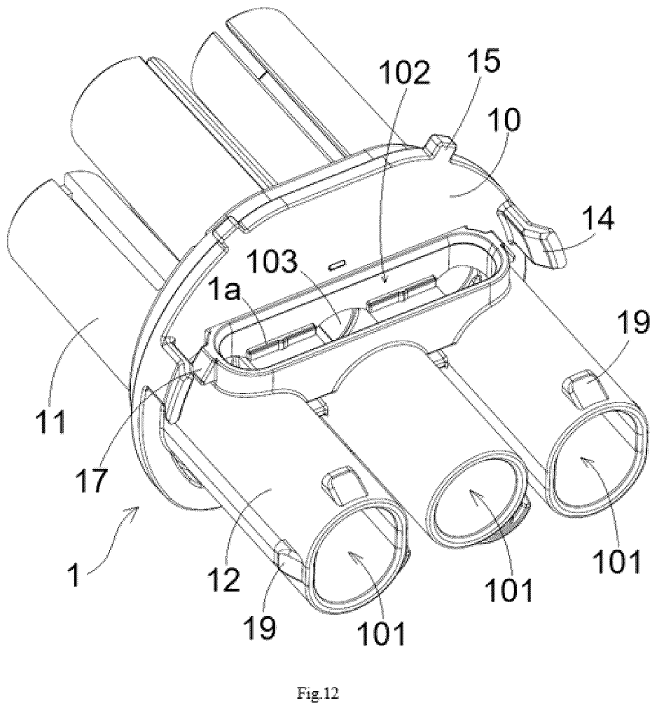

As shown in FIG. 12, in the illustrated embodiment, an opening 103 is formed on the bottom wall of the installation slot 102 to communicate with the terminal insertion hole 101, and the protruding tongue 71 extends into the terminal insertion hole 101 through the opening 103.

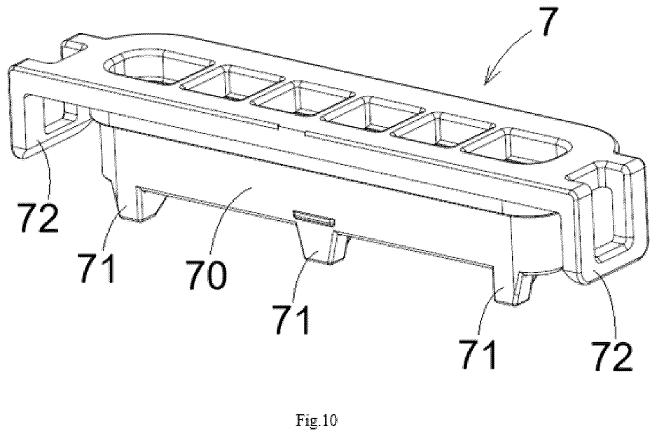

As shown in FIG. 10, in the illustrated embodiment, the locking component 7 further comprises a main body 70 and an elastic buckle 72. The main body 70 is inserted into the installation slot 102. The elastic buckle 72 is connected to the top of the main body 70. A protrusion 17 is formed on the outer side of the peripheral wall of the installation slot 102, which engages with the slot of the elastic buckle 72 to lock the locking component 7 to the housing 1. The protruding tongue 71 is formed on the bottom of the main body 70, and the sealing ring 79 is fitted onto the main body 70.

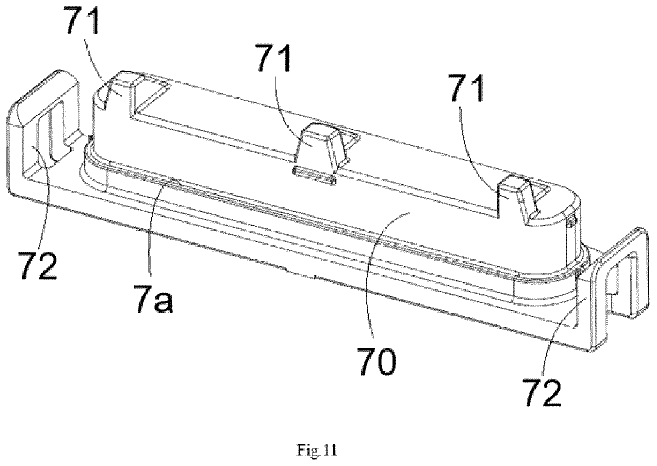

As shown in FIGS. 11 and 12, in the illustrated embodiment, an upper flange 7a is formed on the main body 70 of the locking component 7, and a lower flange 1a is formed on the inner peripheral surface of the installation slot 102. The upper flange 7a and the lower flange 1a respectively abut against the axially opposite ends of the sealing ring 79.

As shown in FIG. 12, in the illustrated embodiment, multiple terminal insertion holes 101 are formed in the housing 1, which extend along a longitudinal direction of the housing 1 and are arranged side by side in the transverse direction of the housing 1. The installation slot 102 extends along the transverse direction of the housing 1 and spans multiple terminal insertion holes 101. The locking component 7 includes multiple protruding tongues 71, which respectively extend into the multiple terminal insertion holes 101 and are used to lock multiple terminals 4 in the multiple terminal insertion holes 101.

As shown in FIG. 12, in the illustrated embodiment, the housing 1 includes a cover plate part 10, a front pillar part 11, and a rear pillar part 12. The cover plate part 10 is used to cover the rear port of the inner cavity 201 of the installation seat 2 of the charging dock. The front pillar part 11 is connected to the front side of the cover plate part 10 and is suitable for insertion into the inner cavity 201 of the installation seat 2. The rear pillar part 12 is connected to the rear side of the cover plate part 10 and aligned axially with the front pillar part 11. The terminal insertion hole 101 extends axially through the rear pillar part 12, the cover plate part 10, and the front pillar part 11.

In the illustrated embodiment, the housing 1 includes multiple front pillar parts 11 and multiple rear pillar parts 12 corresponding to the multiple front pillar parts 11. The housing 1 has multiple terminal insertion holes 101, each of which penetrates axially through a corresponding front pillar part 11 and a corresponding rear pillar part 12.

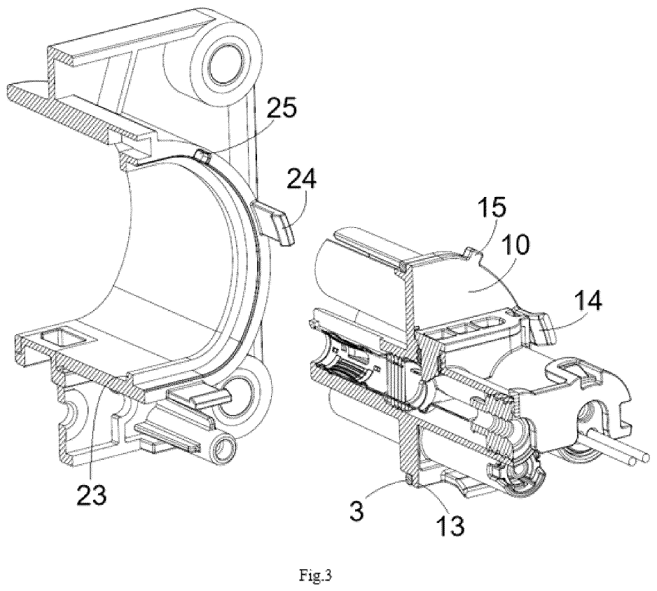

As shown in FIG. 3, in the illustrated embodiment, the charging dock housing assembly further includes a sealing ring 3, which is fitted onto the cover plate part 10. A first flange 13 is formed on the cover plate part 10, and the first flange 13 is axially pressed against the rear side of the sealing ring 3. The sealing ring 3 is suitable for being axially compressed between the first flange 13 and the second flange 23 inside the installation seat 2 to achieve sealing between the installation seat 2 and the housing 1.

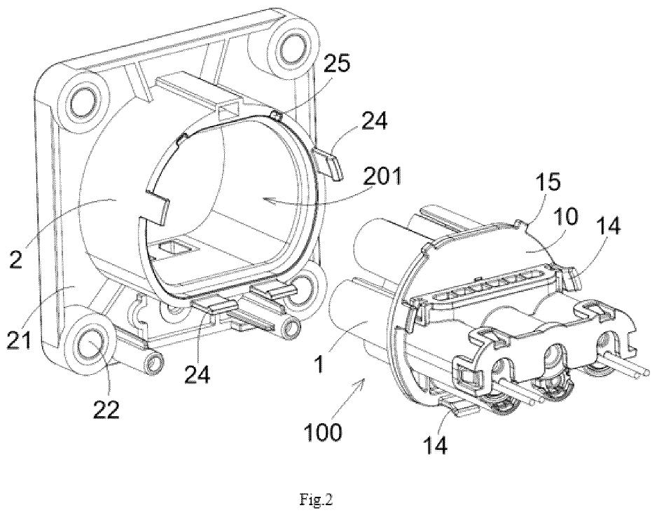

As shown in FIG. 2, in the illustrated embodiment, multiple first elastic claws 14 are formed on the rear side of the cover plate part 10, which are distributed at intervals in the circumferential direction of the cover plate part 10. The multiple first elastic claws 14 are used to engage with multiple second elastic claws 24 on the rear end of the installation seat 2 to lock the housing 1 in the installation seat 2.

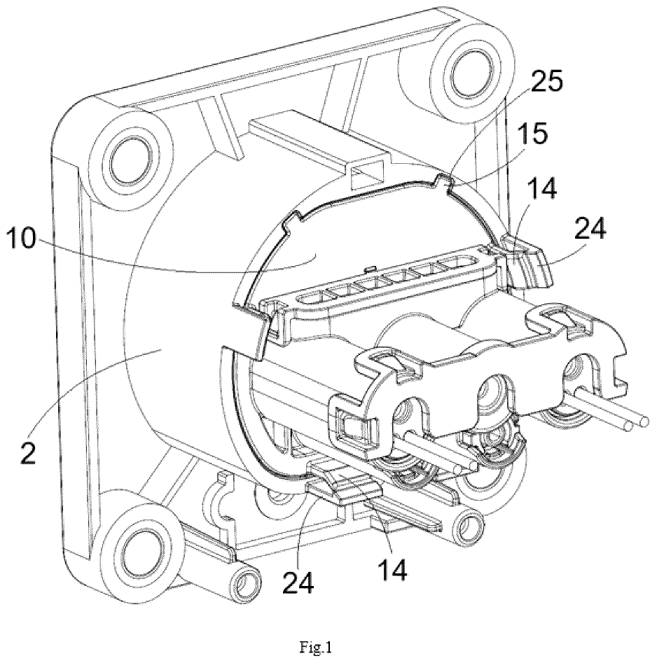

As shown in FIGS. 1 and 2, in the illustrated embodiment, multiple positioning protrusions 15 are formed around the cover plate part 10, which are distributed at intervals in the circumferential direction of the cover plate part 10. The multiple positioning protrusions 15 are used to engage with multiple positioning slots 25 on the rear end surface of the installation seat 2 to position the cover plate part 10 in the circumferential direction.

As shown in FIG. 2, in another exemplary embodiment of the present invention, a charging dock module 100 is also disclosed. The charging dock module 100 includes the aforementioned charging dock housing assembly and an electrical connection assembly. The electrical connection assembly is inserted into the terminal insertion hole 101 of the housing 1. The electrical connection assembly includes a terminal 4, which is locked in the terminal insertion hole 101 of the housing 1 by the locking component 7 to prevent the terminal 4 from being pulled out of the terminal insertion hole 101.

As shown in FIG. 5, in the illustrated embodiment, the terminal 4 includes a terminal body 40, which has a cylindrical part 41 and a welding part 42 connected to the rear end of the cylindrical part 41. The welding part 42 is used to weld to one end 51 of the cable 5 for electrical connection with the cable 5.

In the illustrated embodiment, the electrical connection assembly further comprises: a cable 5 and a temperature sensor 6. One end 51 of cable 5 extends into terminal insertion hole 101 and is welded to the welding part 42 of terminal 4. The temperature sensor 6 is set in the terminal insertion hole 101 and in thermal contact with the welding part 42 of terminal 4, as shown in FIG. 5, used to detect the temperature of terminal 4.

As shown in FIG. 5, in the illustrated embodiment, the electrical connection assembly further includes a sealing plug 8, which is inserted into the rear port of the terminal insertion hole 101. The lead wires 61 of temperature sensor 6 and the cable 5 pass through sealing plug 8 and are led out from the rear end of housing 1. The sealing plug 8 is used to achieve sealing between the cable 5 and the housing 1, as well as between the lead wire 61 and the housing 1.

In the illustrated embodiment, the electrical connection assembly further includes a heat shrink tube, which is fitted and heat shrunk on one end 51 of the cable 5, the welding part 42 of the terminal 4, and the body part 60 of the temperature sensor 6 to fix the temperature sensor 6 to the welding part 42 of the terminal 4.

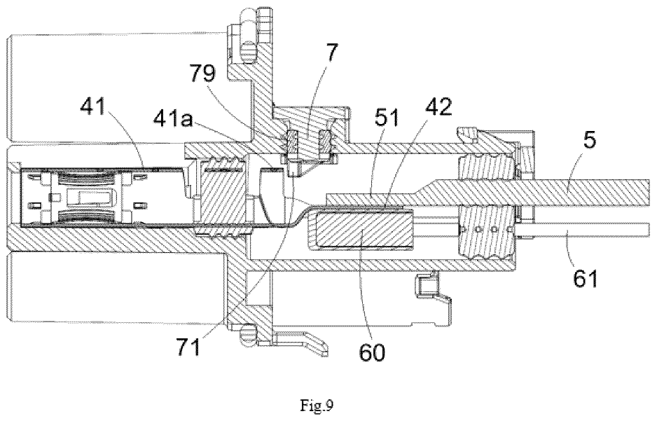

As shown in FIGS. 5 and 9, in the illustrated embodiment, the welding part 42 of terminal 4 is flat and has two opposite sides in its thickness direction. One end 51 of cable 5 is welded to one side of the welding part 42 of terminal 4, and the body part 60 of temperature sensor 6 is fixed to the other side of the welding part 42 of terminal 4.

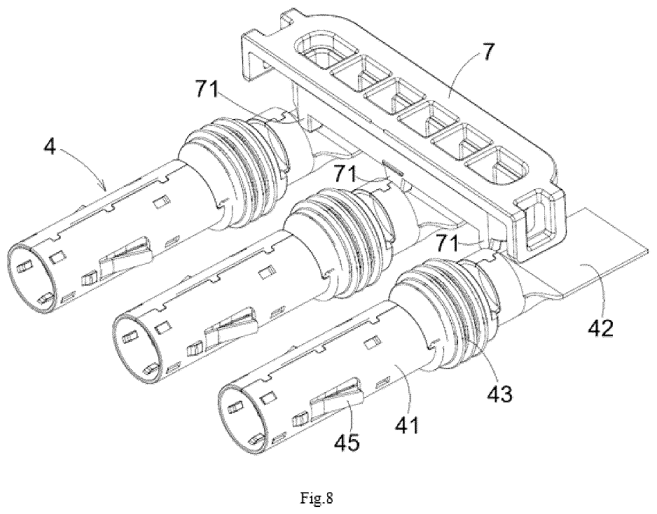

As shown in FIG. 8, in the illustrated embodiment, the electrical connection assembly further includes a sealing element 43, which is injection molded onto the cylindrical part 41 of the terminal 4 and enters the inner cavity of the cylindrical part 41 through the opening on the cylindrical part 41. The sealing element 43 is used to seal the inner cavity of the cylindrical part 41 of terminal 4 and the terminal insertion hole 101 of the housing 1.

As shown in FIG. 5, in the illustrated embodiment, the electrical connection assembly further includes an elastic contact component 44, which is inserted into the front of the cylindrical part 41 of the terminal 4 to make electrical contact with the inserted mating terminal. The terminal body 40 and the elastic contact component 44 are integral stamped parts, respectively.

As shown in FIG. 5, in the illustrated embodiment, the protruding tongue 71 of the locking component 7 is axially pressed against the rear end of the cylindrical part 41 of the terminal 4 to lock the terminal 4 in the terminal insertion hole 101.

As shown in FIG. 8, in the illustrated embodiment, a locking spring 45 is formed on the cylindrical part 41 of the terminal 4, and the locking spring 45 is engaged with the inner wall of the terminal insertion hole 101 to lock the terminal 4 in the terminal insertion hole 101. In the illustrated embodiment, the locking spring 45 is commonly referred to as a primary lock, and the locking component 7 is commonly referred to as a secondary lock.

In the illustrated embodiment, the charging dock module 100 includes multiple electrical connection assemblies, which are respectively inserted into multiple terminal insertion holes 101 of the housing 1. The charging dock module 100 also includes a rear end cover 9, which is installed on the rear end of the housing 1 and axially presses against the sealing plugs 8 of multiple electrical connection assemblies to hold the sealing plugs 8 of the multiple electrical connection assemblies in the multiple terminal insertion holes 101 of the housing 1.

As shown in FIGS. 4 and 12, in the illustrated embodiment, a protrusion 19 is formed on the rear end of the housing 1, and a buckle 91 with a snap slot is formed on the rear end cover 9. The protrusion 19 is engaged into the snap slot of the buckle 91 to fix the rear end cover 9 to the rear end of the housing 1.

In another exemplary embodiment of the present invention, a charging dock is also disclosed. The charging dock includes: an installation seat 2 and a charging dock module 100. The installation seat 2 is formed with an inner cavity 201. The charging dock module 100 is inserted into the inner cavity 201 of the installation seat 2.

As shown in FIG. 3, in the illustrated embodiment, a second flange 23 is formed in the inner cavity 201 of the installation seat 2, which is axially opposite to the first flange 13 on the cover plate part 10 of the housing 1. The sealing ring 3 on the housing 1 is axially compressed between the first flange 13 and the second flange 23 to achieve sealing between the installation seat 2 and the housing 1.

As shown in FIGS. 1 to 3, in the illustrated embodiment, multiple second elastic claws 24 are formed on the rear end of the installation seat 2, and the multiple second elastic claws 24 are distributed at intervals in the circumferential direction of the installation seat 2. The multiple second elastic claws 24 are respectively engaged with the multiple first elastic claws 14 on the rear side of the cover plate part 10 to lock the housing 1 in the installation seat 2.

As shown in FIGS. 1 to 3, in the illustrated embodiment, multiple positioning slots 25 are formed on the rear end face of the installation seat 2. Multiple positioning slots 25 are spaced apart in the circumferential direction of the installation seat 2, and are respectively engaged with multiple positioning protrusions 15 on the cover plate part 10 to position the cover plate part 10 in the circumferential direction.

As shown in FIG. 2, in the illustrated embodiment, the installation seat 2 has a flange part 21, and a connection hole 22 is formed in the flange part 21 to allow a threaded connection member to pass through, so that the flange part 21 can be fastened to a mounting panel (such as a vehicle body sheet metal) through the threaded connection member passing through the connection hole 22.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A charging dock housing assembly, comprising:
a housing having a terminal insertion hole and an installation slot; and
a locking component installed in the installation slot of the housing, the locking component has a protruding tongue extending into the terminal insertion hole, the protruding tongue rests against a terminal inserted into the terminal insertion hole to lock the terminal in the terminal insertion hole.

2. The charging dock housing assembly of claim 1, further comprising a sealing ring fitted onto the locking component and radially compressed between an inner wall surface of the installation slot and the locking component to seal between the inner wall surface and the locking component.

3. The charging dock housing assembly of claim 1, wherein an opening communicated with the terminal insertion hole is formed on a bottom wall of the installation slot, the protruding tongue extends into the terminal insertion hole through the opening.

4. The charging dock housing assembly of claim 3, wherein the locking component further comprises:
a main body inserted into the installation slot; and
an elastic buckle connected to a top of the main body, a protrusion is formed on an outer side of a peripheral wall of the installation slot, the protrusion engages with a slot of the elastic buckle to lock the locking component to the housing, the protruding tongue is formed on a bottom of the main body and a sealing ring is fitted onto the main body.

5. The charging dock housing assembly of claim 1, wherein the housing includes:
a cover plate part covering a rear port of an inner cavity of an installation seat of a charging dock;
a front pillar part connected to a front side of the cover plate part and insertable into the inner cavity of the installation seat; and
a rear pillar part connected to a rear side of the cover plate part and aligned axially with the front pillar part, the terminal insertion hole extends axially through the rear pillar part, the cover plate part, and the front pillar part.

6. The charging dock housing assembly of claim 5, further comprising a sealing ring fitted onto the cover plate part, a first flange is formed on the cover plate part, and the first flange is axially pressed against a rear side of the sealing ring, the sealing ring is axially compressed between the first flange and a second flange inside the installation seat to achieve sealing between the installation seat and the housing.

7. The charging dock housing assembly of claim 5, wherein a plurality of first elastic claws are formed on the rear side of the cover plate part, the first elastic claws are distributed at intervals in a circumferential direction of the cover plate part, the first elastic claws engage with a plurality of second elastic claws on a rear end of the installation seat to lock the housing in the installation seat.

8. The charging dock housing assembly of claim 5, wherein a plurality of positioning protrusions are formed around the cover plate part, the positioning protrusions are distributed at intervals in a circumferential direction of the cover plate part, the positioning protrusions engage with a plurality of positioning slots on a rear end surface of the installation seat to position the cover plate part in the circumferential direction.

9. A charging dock module, comprising:
a charging dock housing assembly, including:
a housing having a terminal insertion hole and an installation slot; and
a locking component installed in the installation slot of the housing, the locking component has a protruding tongue extending into the terminal insertion hole; and
an electrical connection assembly inserted into the terminal insertion hole, the electrical connection assembly includes a terminal, the protruding tongue rests against the terminal to prevent the terminal from being pulled out of the terminal insertion hole.

10. The charging dock module of claim 9, wherein the electrical connection assembly includes:
a cable having an end extending into the terminal insertion hole and welded to a welding part of the terminal; and
a temperature sensor installed in the terminal insertion hole and in thermal contact with the welding part of the terminal, the temperature sensor detecting a temperature of the terminal.

11. The charging dock module of claim 10, wherein the electrical connection assembly includes a sealing plug inserted into a rear port of the terminal insertion hole, a plurality of lead wires of the temperature sensor and the cable pass through the sealing plug and are led out from a rear end of the housing, the sealing plug seals between the cable and the housing and between a lead wire of the plurality of lead wires and the housing.

12. The charging dock module of claim 10, wherein the welding part of the terminal is flat and has a pair of opposite sides in a thickness direction, the end of the cable is welded to a side of the welding part of the terminal, and a body part of the temperature sensor is fixed to another side of the welding part of the terminal.

13. The charging dock module of claim 9, wherein the electrical connection assembly includes a sealing element injected onto a cylindrical part of the terminal and entering an inner cavity of the cylindrical part through an opening on the cylindrical part, the sealing element seals the inner cavity of the cylindrical part of the terminal and the terminal insertion hole of the housing.

14. The charging dock module of claim 9, wherein the electrical connection assembly includes an elastic contact component inserted into a front part of a cylindrical part of the terminal to electrically contact an inserted mating terminal, the terminal body and the elastic contact component are respectively integral stamped parts.

15. The charging dock module of claim 9, wherein the protruding tongue of the locking component is axially pressed against a rear end of a cylindrical part of the terminal to lock the terminal in the terminal insertion hole.

16. The charging dock module of claim 9, wherein a locking spring is formed on a cylindrical part of the terminal, the locking spring is engaged with an inner wall of the terminal insertion hole to lock the terminal in the terminal insertion hole.

17. The charging dock module of claim 11, wherein the electrical connection assembly is one of a plurality of electrical connection assemblies respectively inserted into a plurality of terminal insertion holes of the housing.

18. The charging dock module of claim 17, further comprising a rear end cover installed on the rear end of the housing and axially pressed against a plurality of sealing plugs of the electrical connection assemblies to hold the sealing plugs of the electrical connection assemblies in the terminal insertion holes of the housing.

19. The charging dock module of claim 18, wherein a protrusion is formed on the rear end of the housing, and a buckle with a snap slot is formed on the rear end cover, the protrusion is engaged into the snap slot of the buckle to fix the rear end cover to the rear end of the housing.

20. A charging dock, comprising:
an installation seat having an inner cavity; and
a charging dock module inserted into the inner cavity of the installation seat, the charging dock module including:
a charging dock housing assembly, including:
a housing having a terminal insertion hole and an installation slot; and
a locking component installed in the installation slot of the housing, the locking component has a protruding tongue extending into the terminal insertion hole; and
an electrical connection assembly inserted into the terminal insertion hole, the electrical connection assembly includes a terminal, the protruding tongue rests against the terminal to lock the terminal in the terminal insertion hole and prevent the terminal from being pulled out of the terminal insertion hole.
